(19) United States
(12) Patent Application Publication
(10) Pub. No.: US 2026/0231025 A1
(43) Pub. Date: Aug. 6, 2026

(54) SUBGROUPING BASED ON WAKE-UP DELAY

(71) Applicant: Lenovo (United States) Inc., Morrisville, NC (US)

(72) Inventors: Karthikeyan Ganesan, Kronberg Im Taunus (DE); Ravi Kuchibhotla, Chicago, IL (US); Ali Ramadan Ali, Kraiburg (DE)

(73) Assignee: Lenovo (United States) Inc., Morrisville, NC (US)

(21) Appl. No.: 19/047,200

(22) Filed: Feb. 6, 2025

(51) Int. Cl. H04W 52/02; H04W 68/02

(52) U.S. Cl. CPC H04W 52/0235; H04W 68/025

(57) ABSTRACT

Various aspects of the present disclosure relate to subgrouping based on wake-up delay. A network equipment (NE) determines, for each user equipment (UE) in a group of UEs and based at least in part on both a wake-up delay offset of the UE and an identifier (ID) of the UE, a subgroup of the group of UEs to which the UE belongs. The NE transmits, for each UE in the group of UEs and based at least in part on the subgroup of the UE, a low power wake-up signal (LP-WUS) that identifies the UE.

### TECHNICAL FIELD

The present disclosure relates to wireless communications, and more specifically to subgrouping based on wake-up delay.

### BACKGROUND

A wireless communications system may include one or multiple network communication devices, such as base stations, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive a configuration to monitor a low power wake-up signal occasion (LO) corresponding to a wake-up delay offset of the UE; and monitor the LO based at least in part on the configuration.

A processor (e.g., a standalone processor chipset, or a component of a UE) for wireless communication is described. The processor may be configured to, capable of, or operable to perform one or more operations as described herein. For example, the processor may be configured to, capable of, or operable to receive a configuration to monitor a LO corresponding to a wake-up delay offset of the processor; and monitor the LO based at least in part on the configuration.

A method performed or performable by a UE for wireless communication is described. The method may include receiving a configuration to monitor a LO corresponding to a wake-up delay offset of the UE; and monitoring the LO based at least in part on the configuration.

In some implementations of the UE, processor, and method described herein, the UE, processor, and method may further be configured to, capable of, performed, performable, or operable to monitor the LO for each paging occasion (PO).

In some implementations of the UE, processor, and method described herein, the UE, processor, and method may further be configured to, capable of, performed, performable, or operable to monitor the LO corresponding to one or more paging occasions (POs).

In some implementations of the UE, processor, and method described herein, the wake-up delay offset of the UE is based at least in part on an amount of time taken to wake-up a main radio of the UE.

In some implementations of the UE, processor, and method described herein, the UE, processor, and method may further be configured to, capable of, performed, performable, or operable to transmit an indication of the wake-up delay offset of the UE.

In some implementations of the UE, processor, and method described herein, the LO is in a first paging cycle and the configuration indicates to monitor a PO in a second that is different than the first paging cycle.

An NE (e.g., a base station) for wireless communication is described. The NE may be configured to, capable of, or operable to perform one or more operations as described herein. For example, the NE may be configured to, capable of, or operable to determine, for each UE in a group of UEs and based at least in part on both a wake-up delay offset of the UE and an identifier (ID) of the UE, a subgroup of the group of UEs to which the UE belongs; and transmit, for each UE in the group of UEs and based at least in part on the subgroup of the UE, a low power wake-up signal (LP-WUS) that identifies the UE.

A processor (e.g., a standalone processor chipset, or a component of an NE (e.g., a base station)) for wireless communication is described. The processor may be configured to, capable of, or operable to perform one or more operations as described herein. For example, the processor may be configured to, capable of, or operable to determine, for each UE in a group of UEs and based at least in part on both a wake-up delay offset of the UE and an ID of the UE, a subgroup of the group of UEs to which the UE belongs; and transmit, for each UE in the group of UEs and based at least in part on the subgroup of the UE, a LP-WUS that identifies the UE.

A method performed or performable by an NE (e.g., a base station) for wireless communication is described. The method may include determining, for each UE in a group of UEs and based at least in part on both a wake-up delay offset of the UE and an ID of the UE, a subgroup of the group of UEs to which the UE belongs; and transmitting, for each UE in the group of UEs and based at least in part on the subgroup of the UE, a LP-WUS that identifies the UE.

In some implementations of the NE, the processor, and the method described herein, the wake-up delay offset of the UE is based at least in part on an amount of time taken to wake-up a main radio of the UE.

In some implementations of the NE, processor, and method described herein, the NE, processor, and method may further be configured to, capable of, performed, performable, or operable to receive, for each UE in the group of UEs, an indication of the wake-up delay offset of the UE.

In some implementations of the NE, processor, and method described herein, the NE, processor, and method may further be configured to, capable of, performed, performable, or operable to assign, to the subgroup, a codepoint in a monitoring occasion (MO) of a LP-WUS occasion.

In some implementations of the NE, processor, and method described herein, the NE, processor, and method may further be configured to, capable of, performed, performable, or operable to assign each UE of the group of UEs to a first level subgrouping of multiple first level subgroupings based at least in part on the wake-up delay offset of the UE; and assign, for each UE in a first level subgrouping of the multiple first level subgroupings, based at least in part on the ID of the UE, to a second level subgrouping of multiple second level subgroupings.

In some implementations of the NE, processor, and method described herein, the NE, processor, and method may further be configured to, capable of, performed, performable, or operable to assign, to UEs assigned to different first level subgroupings of the multiple first level subgroupings, different LP-WUS occasions and different periodicities.

In some implementations of the NE, processor, and method described herein, the NE, processor, and method may further be configured to, capable of, performed, performable, or operable to transmit a configuration for a UE of the group of UEs to monitor a PO of multiple POs in a first paging cycle corresponding to a LO in a second paging cycle that is different than the first paging cycle.

In some implementations of the NE, the processor, and the method described herein, the NE comprises a base station.

### BRIEF DESCRIPTION OF THE DRAWINGS

FIG. 1 illustrates an example of a wireless communications system in accordance with aspects of the present disclosure.

FIG. 2 illustrates an example of a low power wake-up radio (LP-WUR) design architecture in accordance with aspects of the present disclosure.

FIG. 3 illustrates an example of an overlaid sequence in accordance with aspects of the present disclosure.

FIG. 4 illustrates an example of a main radio wake-up time in accordance with aspects of the present disclosure.

FIG. 5 illustrates an example of different LP-WUS waveforms in accordance with aspects of the present disclosure.

FIG. 6 illustrates an example of on off keying 4 (OOK-4) signal generation in accordance with aspects of the present disclosure.

FIG. 7 illustrates an example of OOK-1 signal generation in accordance with aspects of the present disclosure.

FIGS. 8 and 9 illustrate examples of monitoring occasions (MOs) in accordance with aspects of the present disclosure.

FIG. 10 illustrates an example of extended discontinuous reception (eDRX) in accordance with aspects of the present disclosure.

FIG. 11 illustrates an example of two-level hierarchical subgrouping in accordance with aspects of the present disclosure.

FIG. 12 illustrates an example of LO and PO associated with different offset or wakeup delay in accordance with aspects of the present disclosure.

FIG. 13 illustrates an example of different LOs associated with different POs in accordance with aspects of the present disclosure.

FIG. 14 illustrates an example of different LOs associated with a same PO in accordance with aspects of the present disclosure.

FIG. 15 illustrates an example of LO and PO association when the wake-up delay is more than the paging cycle in accordance with aspects of the present disclosure.

FIG. 16 illustrates an example of a UE in accordance with aspects of the present disclosure.

FIG. 17 illustrates an example of a processor in accordance with aspects of the present disclosure.

FIG. 18 illustrates an example of an NE in accordance with aspects of the present disclosure.

FIG. 19 illustrates a flowchart of method a performed by a UE in accordance with aspects of the present disclosure.

FIG. 20 illustrates a flowchart of a method performed by an NE in accordance with aspects of the present disclosure.

### DETAILED DESCRIPTION

A UE may operate with different power consumption levels in different power consumption modes, such as in a mode with a high power consumption level (e.g., an active mode, a high-power mode, or a full-power mode) and a mode with a lower power consumption level (e.g., an idle mode, an inactive mode, or a low-power mode). A UE operating in a mode with lower power consumption may operate using reduced transmission and/or reception capabilities (e.g., due to reduced transmit power, energy efficient radio transceivers, low power processors, etc.), may perform energy harvesting techniques to supplement battery power, may utilize sleep modes for different components of the UE, or the like. Examples of UEs that are operable in low power modes include, but are not limited to, internet of things (IoT) devices, wearable devices, remote sensor devices, and mobile devices. In some examples, a wireless device (e.g., a UE) may include multiple components (e.g., multiple radios or multiple receivers), such as a low-power component that operates using a low power consumption level (e.g., a low-power radio, a low-power receiver, or a LP-WUR), and a high-power component that operates at a higher power consumption level (e.g., a main radio, a main receiver). The UE may transition from the high-power component being activated, operating, or executing to the high-power component being not activated, not operating, or not executing, also referred to as the high-power component being put to sleep or transferring to a sleep mode. The UE may transition from the high-power component being not activated, not operating, or not executing to the high-power component being activated, operating, or executing, also referred to as the high-power component being woken up, transferring to a wake mode, or waking up the high-power component.

The UE receives a WUS (e.g., an LP-WUS) from an NE during a LP-WUS MO before a PO. A low-power component (e.g., a low-power radio or a low-power receiver) of the UE radio determines whether the WUS identifies the UE. If the WUS identifies the UE (e.g., identifies a subgroup that includes the UE), the low-power component (e.g., a low-power radio or a low-power receiver) wakes up a high-power component (e.g., a main radio or main receiver) of the UE to receive the PO. If the WUS does not identify the UE (e.g., does not identify a subgroup that includes the UE), the low-power component (e.g., a low-power radio or a low-power receiver) does not wake up the high-power component (e.g., a main radio or main receiver) in response to or based on the received WUS. However, the low-power component (e.g., a low-power radio or a low-power receiver) may wake up the high-power component (e.g., a main radio or main receiver) in response to a subsequently received WUS that does identify the UE.

This disclosure describes a multi-level (e.g., two-level) hierarchical subgrouping of UEs. The first level (the higher level) is wake-up delay based and the second level (the lower level) is UE ID based. The wake-up delay refers to an amount of time between the LO (which refers to when the UE receives the LP-WUS) and when the high-power component (e.g., a man radio or main receive) wakes up (e.g., is activated and able to communicate (e.g., signal, transmit, receive, output, forward, retrieve, obtain) information or data with the NE). The first level of subgrouping includes one subgrouping for each of multiple different wake-up delays that are supported or used by the UE and/or NE, e.g., wake-up delay of 80 ms for a first subgrouping of the first level, a wake-up delay of 500 ms for a second subgrouping of the first level, and a wake-up delay of 900 ms for a third subgrouping of the first level. The second level of subgrouping includes multiple subgroupings based on the IDs of the UEs. Each subgroup of the first level of subgrouping has multiple subgroupings of the second level of subgrouping based on the IDs of the UEs having the wake-up delay of the first level subgroup. For example, for a first subgrouping of the first level having a wake-up delay of 80 ms, there will be multiple subgroupings of the second level including UEs that have a wake-up delay of 80 ms. UEs having a different wake-up delay (e.g., 500 ms or 900 ms) will be in subgroupings under the first level subgroupings having wake-up delays of 500 ms or 900 ms.

This multi-level hierarchical subgrouping of UEs allows the NE to transmit a WUS for just the UEs having a particular wake-up delay, allowing the number of UEs be woken up to be reduced. For example, if a WUS has 32 codewords (e.g., 32 subgroups) instead of all 32 codewords corresponding to a different subgroup, the first 3 codewords can correspond to the first level subgrouping, then the remaining 29 codewords can correspond to the second level subgrouping. This reduces the number of UEs by a given WUS (e.g., there are 3 sets of 29 subgroups each rather than 32 subgroups).

Furthermore, by grouping UEs by wake-up delay, the NE can configure the UEs to stay in a mode with lower power consumption for different durations based on the wake-up delays of the UEs. For example, UEs having a long wake-up delay (e.g., 500 ms or 900 ms) can be configured to sleep for a longer time and then monitor for POs for a longer amount of time before returning to mode with low power consumption, whereas UEs having a short wake-up delay can be configured to sleep for a shorter period of time and then monitor for POs for a shorter amount of time before returning to mode with low power consumption (e.g., since the NE knows the UE will be able to wake up quickly).

If wake-up delay for a UE is short, after waking up ask it to monitor for a short amount of time (since base station knows it can wake up fast).

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

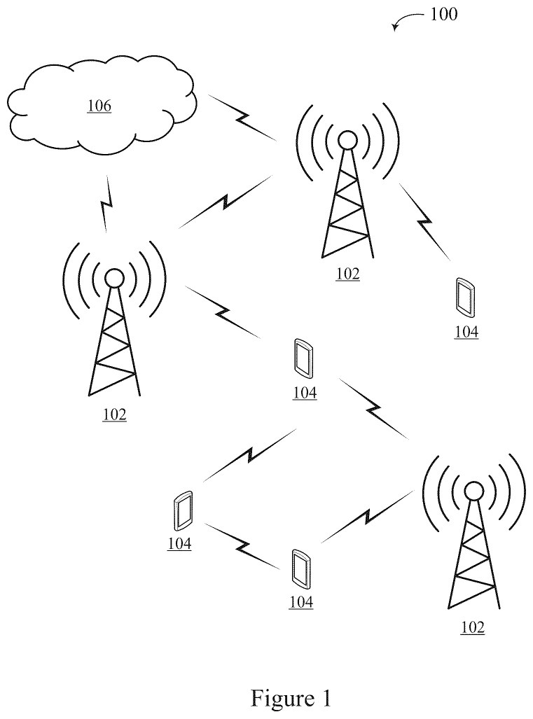

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a new radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

An NE 102 generates subgroups of UEs based at least in part on wake-up delays of the UEs, allowing different WUSs to be communicate (e.g., signaled, transmitted, output, forwarded) to different subgroups of UEs based on their wake-up delays. Different wake-up delays can correspond to different sleep levels or states, including a deep sleep state or level, an ultra deep sleep state or level, and so forth. In a deep sleep state some parts of the high-power component can still be operational or active, such as the receiver chain or physical downlink control channel (PDCCH) reception. In an ultra deep sleep state no reception is performed by the high-power component (e.g., the high-power component is completely turned off).

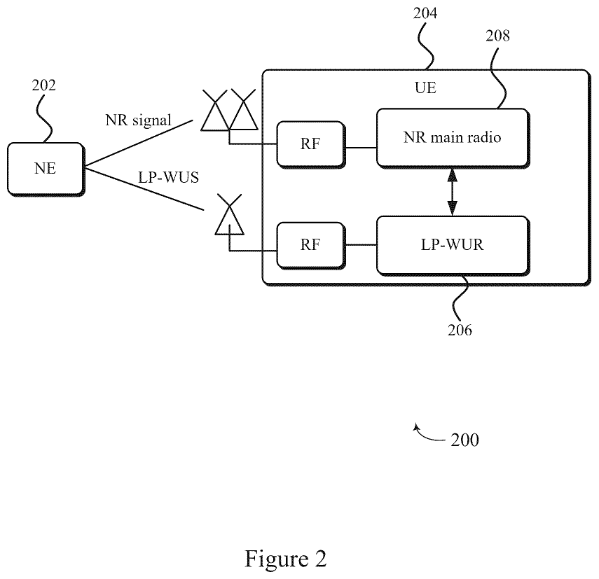

FIG. 2 illustrates an example 200 of a LP-WUR design architecture in accordance with aspects of the present disclosure. The example 200 illustrates an NE 202 (e.g., a base station) and a UE 204. The NE 202 is, for example, an NE 102 of FIG. 1. The UE 204 is, for example, a UE 104 of FIG. 1. The NE 202 transmits a LP-WUS that is received by a LP-WUR 206, which can wake up the main radio 208 (e.g., main receiver) of the UE 204. The UE 204 then communicates (e.g., signals, transmits, receives) with the NE 202 using the main radio. The LP-WUR 206 can be, for example, a chipset separate from the main radio 208, a coprocessor separate from the main radio 208, a configuration within the same main radio 208, and the like.

Use cases for low-power wake-up signal and receiver for NR Air Interface is taken into consideration. These use cases include LP-WUS/LP-WUR for power-sensitive, small form-factor devices including IoT use cases (such as industrial sensors, controllers) and wearables. Other use cases include, e.g., extended reality (XR)/smart glasses, smart phones.

The design of low power wake up signal residing in the low power wake up radio which may be used to wake up the main radio is taken into consideration. For waveform generation the following observations are taken into consideration: flat spectrum in frequency domain provides robustness against frequency selective fading compared to concentrated energy in frequency domain; for OOK-4, sequence before discrete Fourier transform (DFT) or low-band spectrum (LS) with variation in phase via such as Zadoff-Chu (ZC), M-sequence or quadrature amplitude modulation (QAM) sequence can achieve more flattened spectrum; knowledge of one or more sequences used in LP-WUS waveform generation may improve performance for at least a receiver with in-phase and quadrature (I/Q) branches; for waveform-option-3, a harmonized design that accommodates OOK-1/OOK-4 and orthogonal frequency division multiplexing (OFDM) waveform, e.g., specified overlayed orthogonal frequency division multiplexing (OFDM) sequences over OOK symbol; for radio resource control (RRC) IDLE/INACTIVE, in addition to existing primary synchronization signal (PSS) or secondary synchronization signal (SSS), low power synchronization signal (LP-SS) (e.g., one or both of OOK-1/or OOK-4 waveform with or without overlayed OFDM sequences with potential further down selection in WI phase) for LP-WUR that cannot receive existing PSS/SSS, is supported for synchronization and/or radio resource management (RRM) for serving cell.

The problem of power saving as well as coverage associated with the LP-WUR is taken into consideration. The receiver based on envelope detector receiving the OOK waveform improves (e.g., maximizes) the power saving gain compared to the IQ correlator, however the coverage of receiver based on envelope detector is limited compared to the coverage of the IQ correlator receiver type.

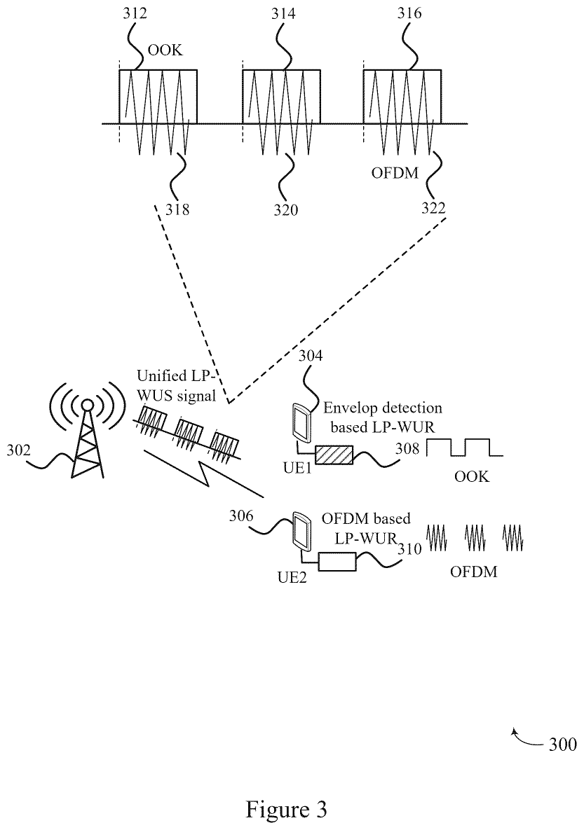

FIG. 3 illustrates an example 300 of an overlaid sequence in accordance with aspects of the present disclosure. The example 300 illustrates an NE 302 (e.g., a base station), a UE 304, and a UE 306. The NE 302 is, for example, an NE 102 of FIG. 1. The UE 304 and the UE 306 are each, for example, a UE 104 of FIG. 1. The UEs 304 and 306 can have different types of receivers, illustrated as UE 304 having an OOK receiver 308 and the UE 306 having an OFDM receiver 310. The NE 302 transmits a waveform that is an overlaid sequence, using OOK and an OFDM sequence during each “on” part of the OOK transmission. For example, during each “on” part 312, 314, and 316 of the OOK transmission, the NE 302 transmits an OFDM sequence 318, 320, and 322, respectively.

Returning to FIG. 2, with respect to the LP-WUR 206, in RRC Idle state the UE 204 receives a wake-up signal and performs a serving cell measurement. In RRC Connected state, the LP-WUS replaces downlink control information (DCI) 2_6—wake-up main radio for connected mode discontinuous reception (C_DRX) active time and the dynamic active timer configuration.

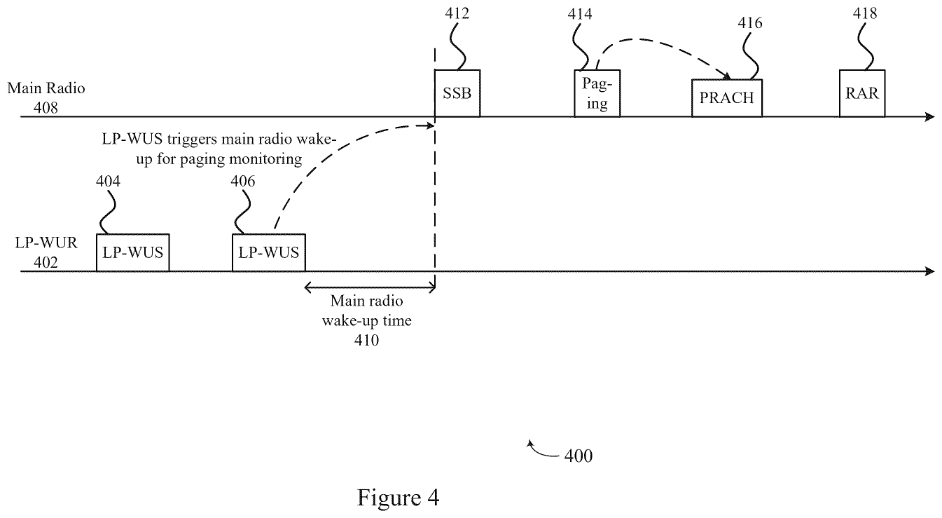

FIG. 4 illustrates an example 400 of a main radio wake-up time in accordance with aspects of the present disclosure. In the example 400, a LP-WUR 402 communicates (e.g., receives) a LP-WUS 404 that does not identify the UE that includes the LP-WUR 402 and LP-WUS 406 that does identify the UE that includes the LP-WUR 402. In response to the LP-WUS 406, the LP-WUR 402 wakes up the main radio 408, which, after the main radio wake-up time 410, communicates (e.g., receives) an SSB 412. The time between receipt of the LP-WUS 406 (e.g., by the LP-WUR 402) and the main radio being active to receive the SSB 412 is the main radio wake-up time 410. The main radio 408 communicates (e.g., receives) a paging signal 414 from a NE and in response communicates a (e.g., transmits, signals, sends) a random access preamble to the NE using a physical random access channel (PRACH) 416. In response, the main radio communicates (e.g., receives) a random access response (RAR) 418 from the NE.

Returning to FIG. 2, for overlaid OFDM sequences for LP-WUS in time or frequency domain, for OOK-1 and OOK-4 M=1. In one or more implementations, one or more overlaid sequences are the one or more sequences of an OOK on symbol before DFT/LS processing for OOK-4 with M=1. ZC sequence in time domain→DFT/LS→iFFT to result in a frequency domain sequence that is ZC sequence or a sequence that is close to ZC sequence, and no additional operation. This does not preclude additional operation for OOK-4 with M>1. DFT size can be 2\hat{ }n. It should be noted that OOK-1 is considered as a specific case of OOK-4 with M=1.

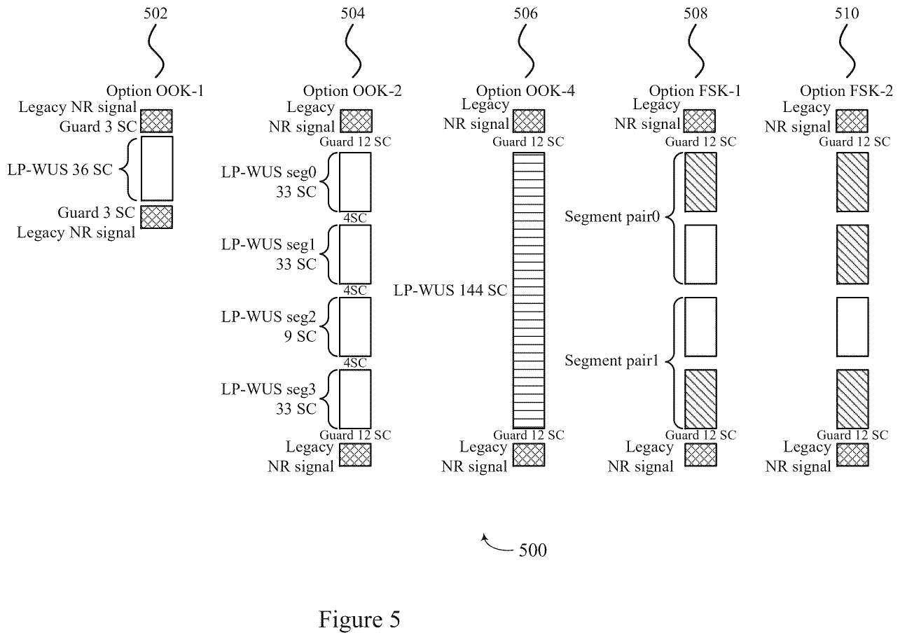

FIG. 5 illustrates an example 500 of different LP-WUS waveforms in accordance with aspects of the present disclosure. The example 500 illustrates an OOK-1 waveform 502, an OOK-2 waveform 504, an OOK-4 waveform 506, a frequency-shift keying (FSK)-1 waveform 508, and an FSK-2 waveform 510.

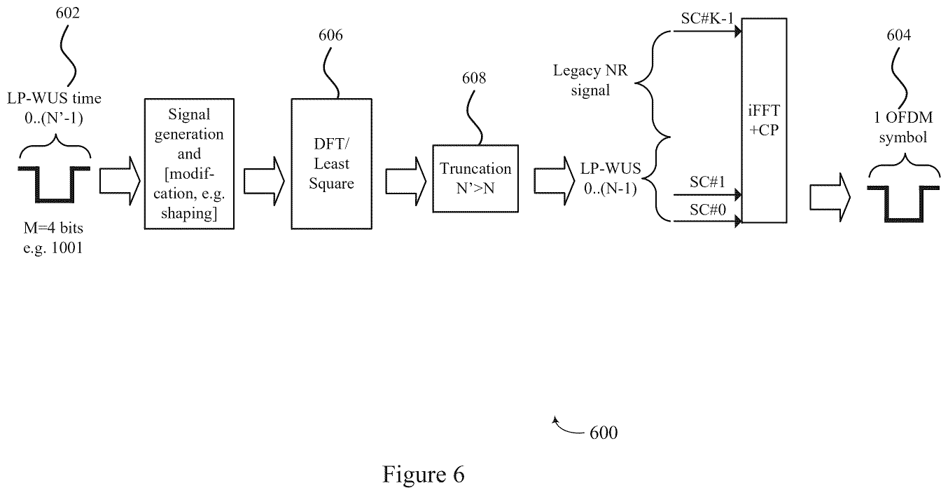

FIG. 6 illustrates an example 600 of OOK-4 signal generation in accordance with aspects of the present disclosure. The example 600 illustrates an input 602 that is converted to an OFDM symbol 604. For transformation of an M-bit OOK in time domain, N SCs of OOK-1 are generated by a transformation 606 (e.g., DFT/Least square). N′ samples are generated from M-bits→‘M’ OOK bits per OFDM symbol. Signal modification may or may not be used. Truncation 608 or other additional modification may or may not be used, and if not used then N is the same as N′. N′ can be the same as K.

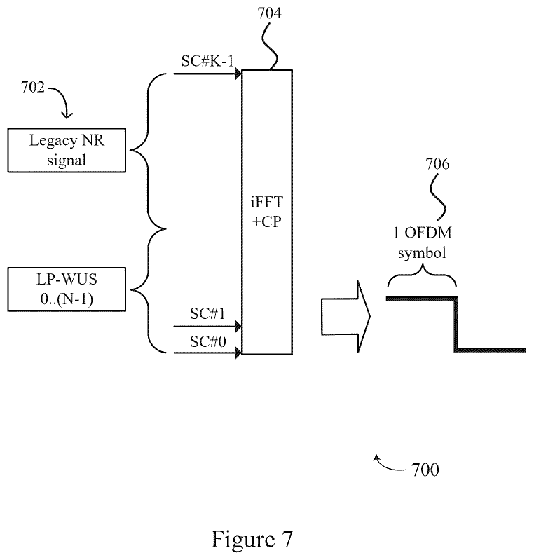

FIG. 7 illustrates an example 700 of OOK-1 signal generation in accordance with aspects of the present disclosure. A signal 702 is input to an inverse Fast Fourier Transform (iFFT) 704 resulting in an OFDM symbol 706. For multi carrier amplitude shift keying (MC-ASK) waveform generation, where K is the size of the iFFT 704 of cyclic prefix orthogonal frequency division multiple access (CP-OFDMA), N is a number of subcarriers (SCs) used by LP-WUS including potential guard-bands. A single-bit in 1 OFDM symbol, SCs of LP-WUS are taken into consideration, where OOK=1 means all SCs are modulated and OOK=0 means all SCs are zero power (from base-band point of view).

Returning to FIG. 2, with regard to the overlaid OFDM sequence(s) of LP-WUS, consider the following options are taken into consideration. In Option 1, a single overlaid sequence is on each OOK ‘ON’ symbol or OFDM symbol duration. OFDM-based LP-WUR can obtain the whole information bits by the presence of the overlaid sequence. In Option 1-2, the overlaid OFDM sequence is pre-determined from multiple sequences. This sequence carries NO information bits of LP-WUS. OFDM-based LP-WUR can obtain the whole information bits by the OOK ON/OFF pattern.

In Option 2, one sequence is selected from multiple candidates overlaid OFDM sequences on each OOK ‘ON’ symbol or OFDM symbol duration, and OFDM-based LP-WUR obtain LP-WUS information at least by overlaid OFDM sequence(s). Two sub-options are taken into consideration. In Option 2-1, the overlaid OFDM sequence(s) carry part of information bits of LP-WUS. OFDM-based LP-WUR can obtain the whole information bits by OFDM sequence(s) and location of the OFDM sequence(s)/OOK symbols. In Option 2-2, the overlaid OFDM sequence(s) carry all information bits of LP-WUS. OFDM-based LP-WUR can obtain the whole information bits by the overlaid OFDM sequence(s).

In Option 3, one sequence is selected from multiple candidates overlaid OFDM sequences on one or more OOK ‘ON’ symbols, and OFDM-based LP-WUR obtains LP-WUS information at least by overlaid OFDM sequence(s). In Option 4, use of modulated overlay sequence with constellation point is used: overlay sequence acting as a spreading sequence and constellation point carrying information for OFDM-based LP-WUR.

In one or more implementations, at least the following codepoints are supported for LP-WUS: one codepoint corresponding to each of the subgroups that can be indicated by LP-WUS, one codepoint corresponding to all the subgroups that can be indicated by LP-WUS, or additional codepoints.

When K (K>1) LP-WUS MOs are configured for each beam in an LO, down select between two options (Option A and Option B) is made.

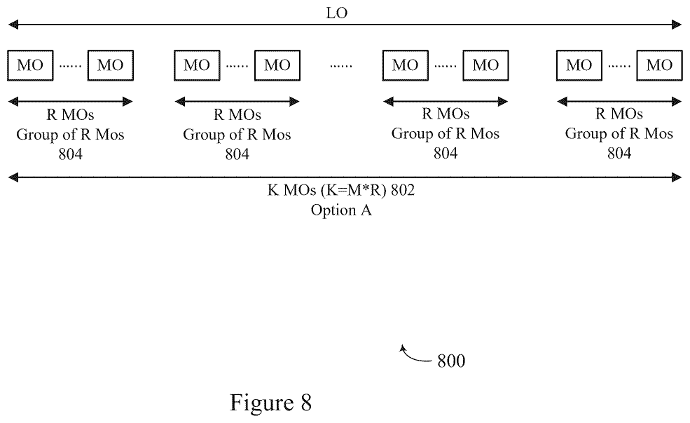

FIG. 8 illustrates an example 800 of monitoring MOs in accordance with aspects of the present disclosure. The example 800 illustrates Option A, where K LP-WUS MOs 802 for a beam are divided into M (M>=1) groups of R LP-WUS MOs 804. A UE monitors all or some of the MO(s) within the K LP-WUS MOs. For each group of R LP-WUS MOs 804, the same LP-WUS information is transmitted. How the same LP-WUS information is transmitted in the R LP-WUS MOs 804 is taken into consideration.

Different LP-WUS information can be transmitted in different groups of R LP-WUS MOs 804. M=1 and M>1 are supported. UE monitoring behavior and R=1 or R>=1 are taken into consideration.

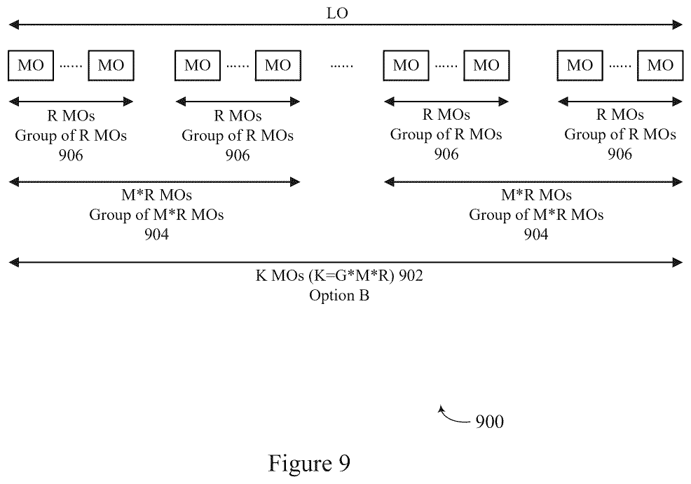

FIG. 9 illustrates another example 900 of monitoring MOs in accordance with aspects of the present disclosure. The example 900 illustrates Option B, where K LP-WUS MOs 902 for a beam are divided into G (G>=1) groups of R*M (M>=1) LP-WUS MOs 904. A UE monitors all or some of the MO(s) within one group of R*M LP-WUS MOs based on its subgroup ID. Each group of R*M LP-WUS MOs is further divided into M groups of R LP-WUS MOs 906. For each group of R LP-WUS MOs 906, the same LP-WUS information is transmitted. How the same LP-WUS information is transmitted in the R LP-WUS MOs is taken into consideration.

Different LP-WUS information can be transmitted in different groups of R LP-WUS MOs. UE monitoring behavior and R=1 or R>=1 are also taken into consideration. M=1 and M>1 are supported.

It should be that noted that Option B achieves the same purpose as Option 3, where UEs monitoring the same PO are divided into multiple sets of subgroups, with UEs within each set of subgroups monitoring the same LO.

Returning to FIG. 2, for the offset value(s) between an LO and a reference PO/paging frame (PF), the following options are taken into consideration. The gap between an LO and a PO is considered to be no less than the wake-up delay the UE 204 supports if the gap between the end of the last LP-WUS MO the UE monitors in the LO and the start of the PO is no less than the wake-up delay. In a first option (Option 1), the NE 202 configures a single offset value. If the gap between an LO and the PO associated with the offset is no less than the wake-up delay the UE 204 supports, the UE 204 monitors the PO associated with the offset after receiving a wake-up indication in a LP-WUS. Otherwise, in a sub-option (Option 1-1) the UE 204 follows the legacy paging monitoring procedure, or in another sub-option (Option 1-2) the UE 204 monitors LP-WUS (and if the UE 204 receives a wake-up indication in a LP-WUS, the UE 204 monitors the first PO after its reported wake-up delay).

In a second option (Option 2), the NE 202 configures one or multiple offset values. For the same PO, each offset corresponds to a LO. This does not preclude the possibility that the same LO may correspond to different POs with different offset values. In a first sub-option (Option 2A), the UE 204 does not expect that the gap between the LO associated with the largest offset and the corresponding PO is less than the wake-up delay the UE 204 supports. The UE 204 monitors the LO associated with one offset that has a gap between the LO and the corresponding PO no less than the wake-up delay. This implies that the NE 202 configures at least one offset value that is no less than the largest wake-up delay supported by the UEs. How to choose the offset is taken into consideration. In a second sub-option (Option 2B), if the gap between the LO associated with the largest offset and the corresponding PO is no less than the wake-up delay the UE 204 supports, the UE 204 monitors the LO associated with one offset that has a gap between the LO and the PO associated with the offset no less than the wake-up delay. How to how to choose the offset is taken into consideration. Otherwise, in a further sub-option (Option 2B-1), the UE 204 follows the legacy paging monitoring procedure, or in another further sub-option (Option 2B-2), the UE 204 monitors LP-WUS (if the UE 204 receives a wake-up indication in a LP-WUS, the UE 204 monitors the first PO after its reported wake-up delay; how to choose the offset is taken into consideration. For the second option (Option 2), the UE 204 monitoring the LO associated with additional offset(s) is taken into consideration.

It should be noted that, for the Option 1 and Option 2, the PO mentioned above refers to legacy PO configured for the UE 204.

In one or more implementations, the UEs monitoring the same PO are divided into multiple subgroups, where LP-WUS can provide wake-up indication for each subgroup. The following options are considered: UEs monitoring the same PO monitor the same LO; UEs corresponding to different POs monitor the same LO; UEs monitoring the same PO are divided into multiple sets of subgroups, with UEs within each set of subgroups monitoring the same LO; or combinations of these options.

For the offset value(s) between an LO and a reference PO/PF, down-select between Option 1-1, configurability between Option 1-1 and Option 1-2, and Option 2B-1 is taken into consideration.

At least for the 1:1 LO to PO mapping, the maximum value of M for Option A (illustrated in example 800 of FIG. 8) or Option B (illustrated in example 900 of FIG. 9) with G=1 (if either of them is supported) is 4 is taken into consideration.

Whether to support additional codepoints indicating wake-up at least for 1:1 LO to PO mapping is also taken into consideration.

The following alternatives, any one or more of which can be implemented together, for UE capability report on the wake-up delay are taken into consideration. In a first alternative, for the three candidate values for the wake-up delay capability report, support 80 ms, 500 ms, and 900 ms. The reported values assume synchronization signal block (SSB) periodicity of 20 ms, where 80 ms assumes three SSBs used for synchronization, 500 ms and 900 ms assume 5 SSBs used for synchronization. Translation of wake-up delay for different SSB periodicities is taken into consideration.

In a second alternative, for the wake-up delay capability report, the UE reports a pair of values for main radio ramp up and the number of SSBs used for synchronization (D, NSSB). The following three candidate capabilities are supported: (20 ms, 3), (400 ms, 5), and (800 ms, 5).

In a third alternative, modification is made to the previous consideration on UE capability report on the wake-up delay to UE capability report on the main radio ramp up time. The number of SSBs used for synchronization is defined in specs, and different number of SSBs can be defined for different UE capability on the main radio ramp up time. Three candidate values for the main radio ramp up time: 20 ms, 400 ms, 800 ms. The number of SSBs used for synchronization is defined as [3, 5, 5] for [20 ms, 400 ms, 800 ms] main radio ramp up time, respectively.

In a fourth alternative, modification is made to the previous consideration on UE capability report on the wake-up delay to UE capability report on the main radio ramp up time. The time needed for synchronization can be taken into consideration.

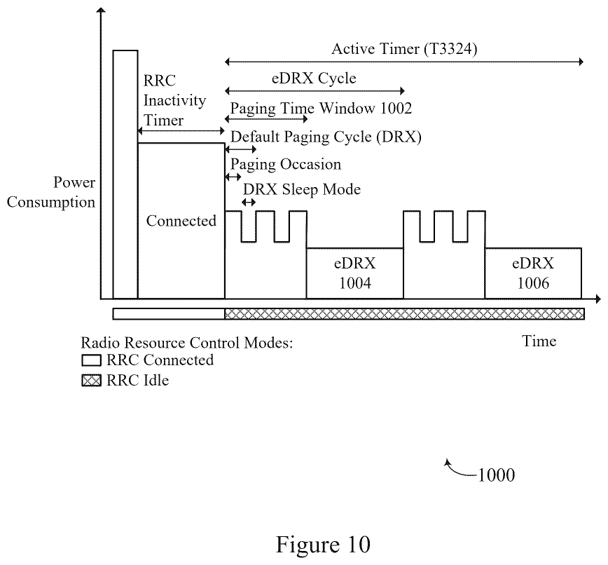

FIG. 10 illustrates an example 1000 of eDRX in accordance with aspects of the present disclosure. eDRX allows devices (e.g., UEs) to enter the deep sleep state or level, or the ultra deep sleep state or level. eDRX includes a paging time window (PTW) 1002 and one or more eDRX periods (an idle period), illustrated as eDRX periods 1004 and 1006. The PTW is a short interval where the device (e.g., a UE) actively listens for incoming data. The PTW itself is divided into even shorter periods of active listening (POs) interspersed with short sleep periods (DRX). Regarding the eDRX period, during the eDRX period the device (e.g., a UE) ignores paging and downlink control channels. More than one eDRX cycle may be present within the active timer.

Returning to FIG. 2, Table 1 illustrates LP-WUS resource overhead for OOK-4 calculated for different values and repetitions. Included in Table 1 are columns for the scheme (where M refers to the number of OOK chips), subgroups (SGs), and information (info) bits that allow the 32 subgroups (e.g., each subgroup corresponding to a different codeword) to be identified. Also included are columns for cyclic redundancy check (CRC) bits, the number of bits after performing Manchester coding, a number of repetitions (Num Rep) of OFDM symbols, and an MO length that is equal to the number of OFDM symbols. Also included are columns for the number of beams (No of beams) for transmitting the LP-WUS, e.g., using FR1, and the total LO duration (in milliseconds) for the LP-WUS.

TABLE 1

| | | | | | | OFDM | | Total LO |
|---|---|---|---|---|---|---|---|---|
| | | | | Bits after | | symbols = | | duration (ms) = |
| | | Info | CRC | Manchester | Num | MO | No of | SGs*rep* |
| Scheme | SGs | bits | bits | coding | Rep | length | beams | num beams |
| OOK-4, | 32 | 5 | 3 | (5 + 3)*2 = 16 chips | 1 | 4 | 8 | 74 |
| M = 4 | | | | | | | | |
| OOK-4, | 32 | 5 | 3 | (5 + 3)*2 = 16 chips | 1 | 8 | 8 | 148 |
| M = 2 | | | | | | | | |
| OOK = 4, | 32 | 5 | 3 | (5 + 3)*2 = 16 chips | 1 | 16 | 8 | 293 |
| M = 1 | | | | | | | | |
| OOK-4, | 32 | 5 | 3 | (5 + 3)*2 = 16 chips | 2 | 8 | 8 | 4.6 × 32 = |
| M = 4 | | | | | | | | 147.2 |
| OOK-4, | 32 | 5 | 3 | (5 + 3)*2 = 16 chips | 2 | 16 | 8 | 9.2 × 32 = |
| M = 2 | | | | | | | | 295 |
| OOK = 4, | 32 | 5 | 3 | (5 + 3)*2 = 16 chips | 2 | 32 | 8 | 586 |
| M = 1 | | | | | | | | |
| OOK-4, | 32 | 5 | 3 | (5 + 3)*2 = 16 chips | 4 | 16 | 8 | 293 |
| M = 4 | | | | | | | | |
| OOK-4, | 32 | 5 | 3 | (5 + 3)*2 = 16 chips | 4 | 32 | 8 | 586 |
| M = 2 | | | | | | | | |
| OOK = 4, | 32 | 5 | 3 | (5 + 3)*2 = 16 chips | 4 | 64 | 8 | 1171 |
| M = 1 | | | | | | | | |

In one or more implementations, the first level subgrouping can be based on wake-up delay capability reported by one or more UEs 104 to the NE 102, or offset, for a UE 104, between the LO and the PO which are no less than the wake-up delay of the UE 104. The offset value between an LO and a reference PO/PF refers to the gap between an LO and a PO being considered to be no less than the wake-up delay the UE 104 supports if the gap between the end of the last LP-WUS MO the UE 104 monitors in the LO and the start of the PO is no less than the wake-up delay.

Two level subgrouping using hierarchical methodology can be defined explicitly or implicitly by creating a first level subgrouping according to the wake-up delay or offset of a UE 104, e.g., the LP-WUR 206 waking up the main radio of the UE 104 or an offset between the LO and the PO and the second level subgrouping can be defined according to the UE ID based subgrouping corresponding to that of first level wake-up delay subgroup hence further reducing the number of UEs waking up to monitor a PO as explained in the following example of determining the identifier of a second level subgrouping (Subgroup ID) for a UE having a 5G-S-temporary mobile subscriber identity (TMSI):

$$SubgroupID = ( floor ( UE\_ID / ( N * Ns ) ) mod subgroupsNumForUEID ) + ( subgroupsNumPerPO - subgroupsNumForUEID )$$

where N refers to the number of total paging frames in T; which is the DRX cycle of RRC_IDLE state; Ns refers to the number of paging occasions for a PF; UE_ID refers to the 5G-S-TMSI mod X, where X is 32768, if eDRX is applied, otherwise, X is 8192; subgroupsNumPerPO refers to the number of subgroups per PO, and subgroupsNumForUEID refers to the number of subgroups for UE_ID based subgrouping in a PO, which is broadcasted in system information.

The techniques discussed herein reduce the number of UEs to be woken up, first by subgrouping the UEs according to the wake-up delay or offset between LO and PO and secondly, by further subgrouping the UEs according to their UE ID. The wake-up delay or offset can be, for example, 80 ms, 500 ms, or 900 ms depending on whether the main radio is in the deep sleep state or in the ultra-deep sleep state and hence at least three different subgroups can be defined for this purpose.

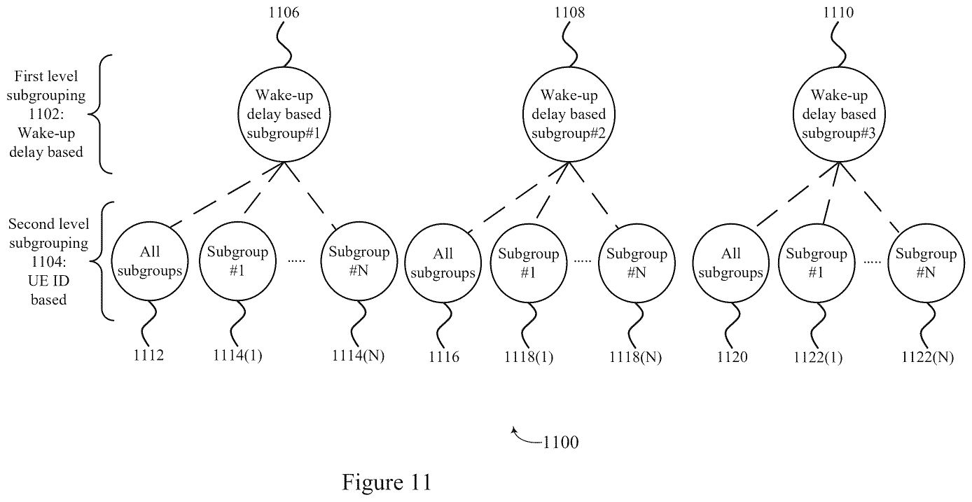

FIG. 11 illustrates an example of two-level hierarchical subgrouping 1100 in accordance with aspects of the present disclosure. The two-level hierarchical subgrouping 1100 includes a first level subgrouping 1102 that is wake-up delay based and a second level subgrouping 1104 that is UE ID based. In the first level subgrouping 1102 three subgroups 1106, 1108, and 1110 are illustrated. Each of the three subgroups 1106, 1108, and 1110 corresponds to a different one of the different wake-up delays or offsets (e.g., 80 ms, 500 ms, and 900 ms).

In the second level subgrouping 1104, there are multiple (N+1) subgroups 1112 and 1114(1), . . . , 1114(N) below the subgroup 1106. The subgroup 1112 refers to all second level subgroups below the subgroup 1106, and the subgroups 1114(1), . . . , 1114(N) refer individual UEs. In the second level subgrouping 1104, there are also multiple (N+1) subgroups 1116 and 1118(1), . . . , 1118(N) below the subgroup 1108. The subgroup 1116 refers to all second level subgroups below the subgroup 1108, and the subgroups 1118(1), . . . , 1118(N) refer to individual UEs. In the second level subgrouping 1104, there are also multiple (N+1) subgroups 1120 and 1122(1), . . . , 1122(N) below the subgroup 1110. The subgroups 1122(1), . . . , 1122(N) refers to all second level subgroups below the subgroup 1110, and the subgroups 1122(1), . . . , 1122(N) refer to individual UEs.

In one or more implementations, dedicated codepoint in a MO of an LO is assigned to indicate wake-up delay or offset (also referred to as explicitly configuring the subgroups). The first codepoint in a MO of an LP-WUS occasion correspondingly indicates the UEs belonging to a certain wake-up delay or offset, while the second codepoint in the MO indicates all subgroups within that wake-up delay or offset group, and the rest of the codepoints in the MO indicates the UE ID based subgrouping corresponding to a wake-up delay or offset between LO or PO. This mechanism allows the NE 102 to configure multiple offsets and allows the NE 102 to dynamically indicate the subgroups to be woken up by indicating the codepoint corresponding to the wake-up delay or offsets as part of the hierarchical subgrouping scheme. Since the offsets for the subgroups are semi-statically configured, the UE 104 may monitor the PO associated with the offset after it receives the dynamic indication from the NE 102. The UE 104 may monitor the first PO of its paging frame after waking up or may monitor its PO from the reference PO as configured by the NE 102.

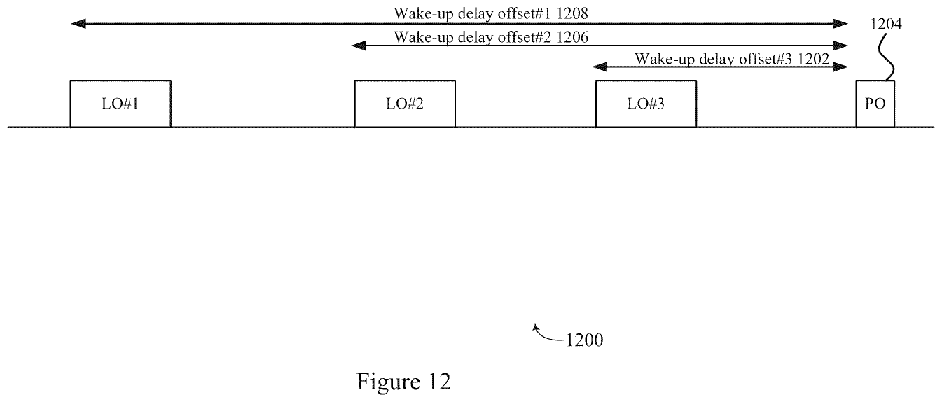

FIG. 12 illustrates an example 1200 of LO and PO associated with different offset or wake-up delay in accordance with aspects of the present disclosure. LOs are separately provided for each wake-up delay or offset (also referred to as implicitly configuring the subgroups). For example, as illustrated in the example 1200, a UE 104 having a shorter wake-up delay, corresponding to wake-up delay offset 1202, is associated with a PO 1204. Multiple UEs each having a longer wake-up delay, corresponding to wake-up delay offset 1206 or wake-up delay offset 1208, are associated with the PO 1204. LP-WUS occasions and periodicity itself can be classified and further distinguished according to the wake-up delay or offsets and each LP-WUS occasion corresponding to each wake-up delay or offset can have different periodicities depending on the wake-up delays or offset. For example, the shorter periodicity can be configured for UEs having shorter wake-up delay offset meaning UEs having a shorter wake-up delay may be expected to monitor for LP-WUS occasions more often, whereas the longer periodicity can be configured for UEs having longer wake-up delay offset meaning UEs having a longer wake-up delay may be expected to monitor for LP-WUS occasions less often.

The LO to PO association can be configured one to one for the UEs 104 having a shorter wake-up delay while UEs 104 having longer wake-up delay or offset may be configured to be associated to multiple POs for each LO. The wake-up delay-based LO to PO offset association can further depend on the number of subframes for POs configured per paging cycle, in cases of multiple POs per paging frame or paging cycle, then the UE 104 with large wake-up delay or offsets may be configured to monitor multiple POs in a paging frame or paging cycle.

Returning to FIG. 1, a UE 104 may be configured to monitor its LO corresponding to its wake-up delay or offsets and such a UE 104 can be configured to monitor LO corresponding to each PO in case of shorter wake-up delay or offsets. In case of longer wake-up delay, the UE may be configured to monitor LO corresponding to one or more PO.

In the above example, the number of MOs per LO can be configured up to 4, for example, and such MOs can be configured for different wake-up delay groups.

The LO can be configured in one of the following ways.

The LO can be configured to contain ‘M*R’ MOs or ‘G group of M*R’ MOs, where M is the number of subgroups, which can be, for example, up to 4 and R is the number of repetitions, which can be, for example, up to 2 or 4. In a case that the LO contains M groups of MOs, then codepoints corresponding to all the subgroups can be transmitted in each group of LO (i.e., MO #1 of LO #1 and MO #1 of LO #2) and may imply wakeup all subgroups or subgroups associated with the LO associated to a PO or group of MOs. In another option, the codepoint corresponding to all subgroups can be transmitted in a MO of a LO whose periodicity and MOs can be configured and provided to the UE.

Different subgroups can be transmitted in different LOs associated to the same PO with different offsets or different POs belonging to the same or different paging frame or paging cycle or a combination thereof with different offsets.

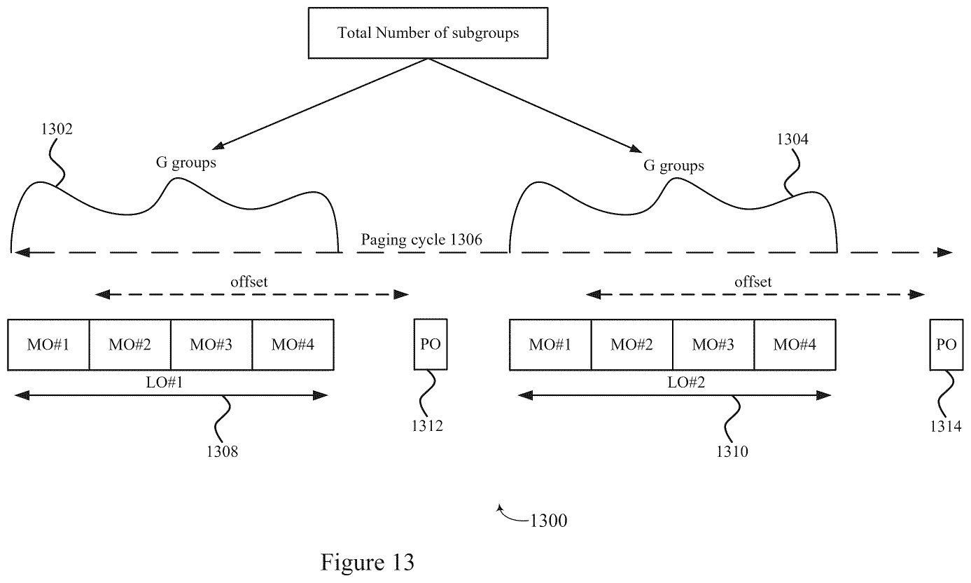

FIG. 13 illustrates an example 1300 of different LOs associated with different POs in accordance with aspects of the present disclosure. The example 1300 illustrates two groups of subgroups, group 1302 and group 1304, in a paging cycle 1306, each group including a LO (LO 1308 and LO 1310). The LO 1308 is associated with a PO 1312 and the LO 1310 is associated with a PO 1314. Accordingly, the LOs 1308 and 1310 are associated with different POs.

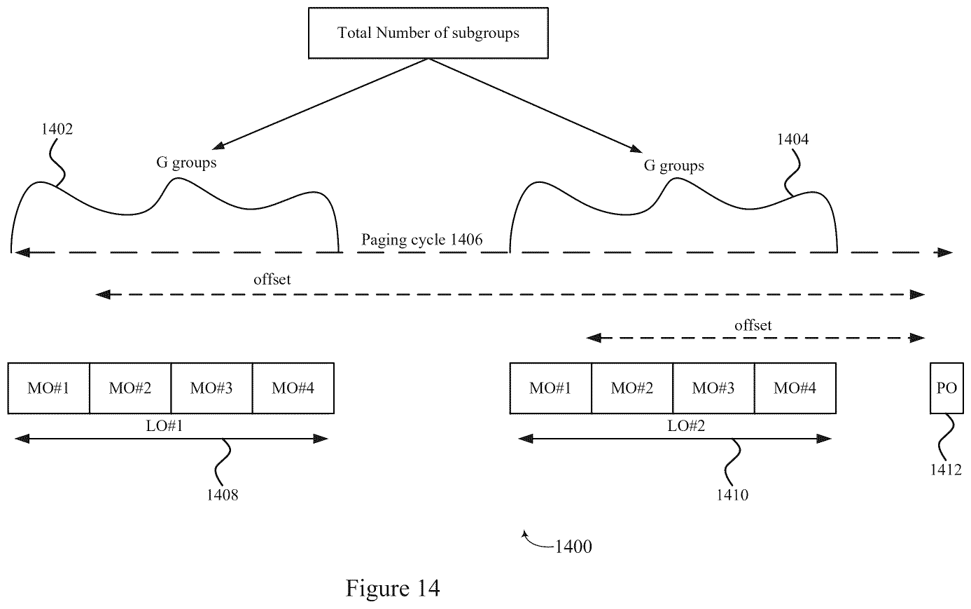

FIG. 14 illustrates an example 1400 of different LOs associated with a same PO in accordance with aspects of the present disclosure. The example 1400 illustrates two groups of subgroups, group 1402 and group 1404, in a paging cycle 1406, each group including a LO (LO 1408 and LO 1410). The LO 1408 and the LO 1410 are associated with different offset or wake-up delays but are associated with the same PO (PO 1412).

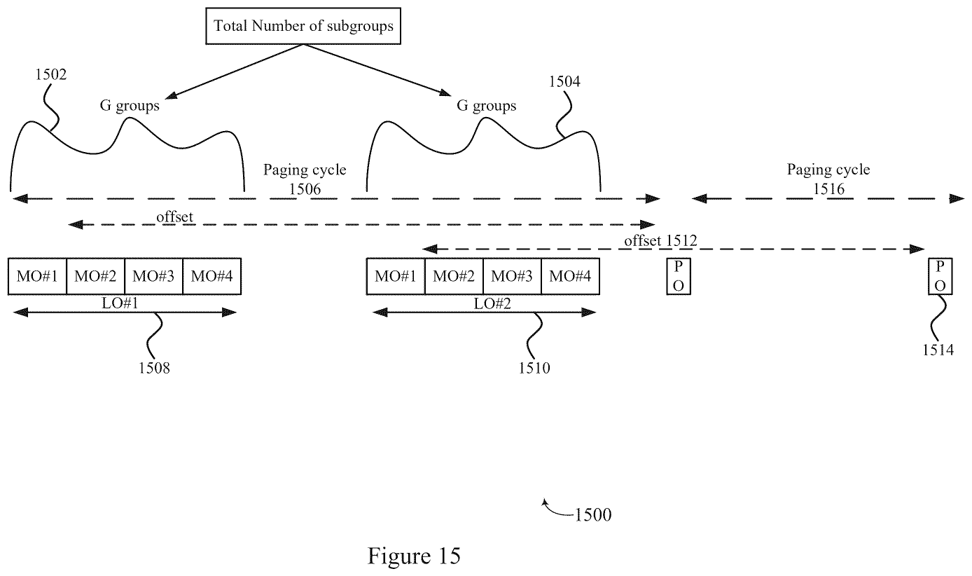

FIG. 15 illustrates an example 1500 of LO and PO association when the wake-up delay is more than the paging cycle in accordance with aspects of the present disclosure. In cases that a wake-up delay or offset is more than or exceeds the configured paging cycle in a cell, then the LO to PO association can span across paging frames belonging to different paging cycles. Hence, the UE 104 may be configured to monitor different POs corresponding to a LO. The example 1500 illustrates two groups of subgroups, group 1502 and group 1504, in a paging cycle 1506, each group including a LO (LO 1508 and LO 1510). As illustrated in the example 1500, the UE 104 can have a large wakeup delay or offset (e.g., wake-up delay or offset 1512 of 400 ms) that can span from the LO 1510 in the paging cycle 1506 to a PO 1514 in another paging cycle 1516.

Returning to FIG. 2, in one or more implementations first level grouping is according to the device types e.g., eMBB, IoT/low power wide area (LPWA), rather than wake-up delay. In such situation, the two-level hierarchical subgrouping can include device type indication implicitly or explicitly as explained in the above discussions to support the first level subgrouping according to the device type and the second level subgrouping according to the UE ID corresponding to its device type. Each of these device types could have different wake-up delay or offsets and different paging cycles, and the device type ensures that the paging occasions can be monitored within a paging cycle within an idle mode discontinuous reception (IDRX) or paging occasions monitored within a paging time window within an eDRX cycle.

Accordingly, UEs can be sub-grouped according to the wake-up delay offset implicitly or explicitly as discussed herein. Two level hierarchical subgrouping where the first level of subgrouping can be configured based on the wake-up delay offset while second level of subgrouping corresponds to the UE ID based is also discussed herein. LP-WUS occasions can be separately associated for every wake-up delay offset is also discussed herein. One to one LO: PO association and one to many LO: PO association depending on the wake-up delay offset is also discussed herein.

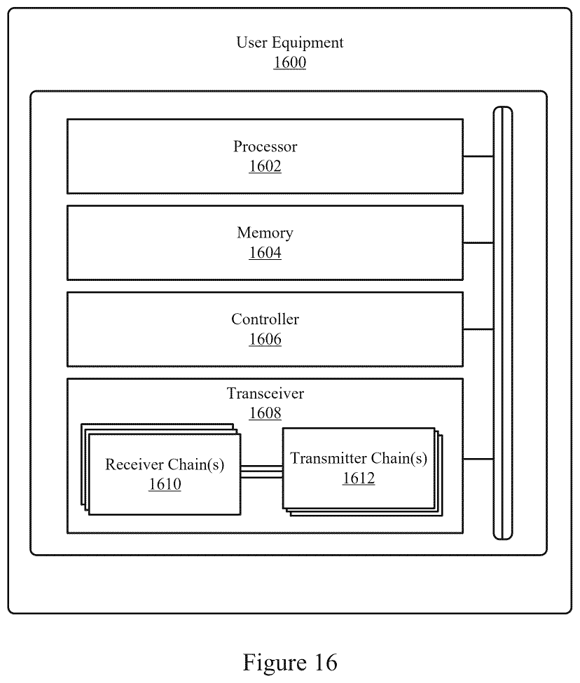

FIG. 16 illustrates an example of a UE 1600 in accordance with aspects of the present disclosure. The UE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the UE 1600 to perform various functions of the present disclosure.

The memory 1604 may include volatile or non-volatile memory. The memory 1604 may store computer-readable, computer-executable code including instructions when executed by the processor 1602 cause the UE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the UE 1600 to perform one or more of the functions described herein (e.g., executing, by the processor 1602, instructions stored in the memory 1604). For example, the processor 1602 may support wireless communication at the UE 1600 in accordance with examples as disclosed herein. The UE 1600 may be configured to or operable to support a means for receiving a configuration to monitor a LO corresponding to a wake-up delay offset of the UE; and monitoring the LO based at least in part on the configuration.

Additionally, the UE 1600 may be configured to support any one or combination of monitoring the LO for each PO; monitoring the LO corresponding to one or more POs; where the wake-up delay offset of the UE is based at least in part on an amount of time taken to wake-up a main radio of the UE transmitting an indication of the wake-up delay offset of the UE; where the LO is in a first paging cycle and the configuration indicates to monitor a PO in a second that is different than the first paging cycle.

Additionally, or alternatively, the UE 1600 may support at least one memory (e.g., the memory 1604) and at least one processor (e.g., the processor 1602) coupled with the at least one memory and configured to cause the UE to: receive a configuration to monitor a LO corresponding to a wake-up delay offset of the UE; and monitor the LO based at least in part on the configuration.

Additionally, the UE 1600 may be configured to support any one or combination of the at least one processor is configured cause the UE to monitor the LO for each PO; the at least one processor is configured cause the UE to monitor the LO corresponding to one or more POs; where the wake-up delay offset of the UE is based at least in part on an amount of time taken to wake-up a main radio of the UE the at least one processor is configured cause the UE to transmit an indication of the wake-up delay offset of the UE; where the LO is in a first paging cycle and the configuration indicates to monitor a PO in a second that is different than the first paging cycle.

The controller 1606 may manage input and output signals for the UE 1600. The controller 1606 may also manage peripherals not integrated into the UE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the UE 1600 may include at least one transceiver 1608. In some other implementations, the UE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, packets) over a wireless medium. For example, the receiver chain 1610 may include one or more antennas to receive a signal over the air or wireless medium. The receiver chain 1610 may include at least one amplifier (e.g., a low-noise amplifier (LNA)) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the demodulated signal to receive the transmitted data.

A transmitter chain 1612 may be configured to generate and transmit signals (e.g., control information, data, packets). The transmitter chain 1612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

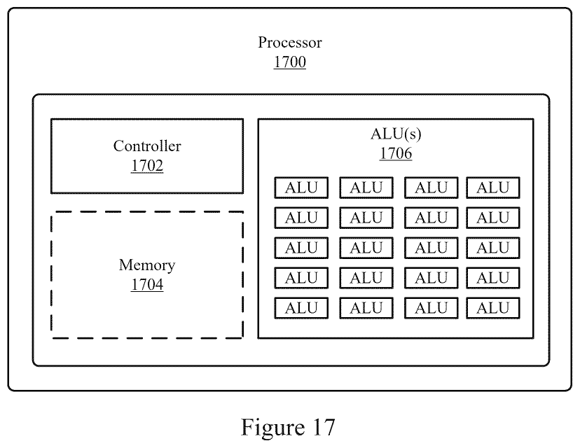

FIG. 17 illustrates an example of a processor 1700 in accordance with aspects of the present disclosure. The processor 1700 may be an example of a processor configured to perform various operations in accordance with examples as described herein. The processor 1700 may include a controller 1702 configured to perform various operations in accordance with examples as described herein. The processor 1700 may optionally include at least one memory 1704, which may be, for example, an L1/L2/L3 cache. Additionally, or alternatively, the processor 1700 may optionally include one or more arithmetic-logic units (ALUs) 1706. One or more of these components may be in electronic communication or otherwise coupled (e.g., operatively, communicatively, functionally, electronically, electrically) via one or more interfaces (e.g., buses).

The processor 1700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1702 may be configured to manage and coordinate various operations (e.g., signaling, receiving, obtaining, retrieving, transmitting, outputting, forwarding, storing, determining, identifying, accessing, writing, reading) of the processor 1700 to cause the processor 1700 to support various operations in accordance with examples as described herein. For example, the controller 1702 may operate as a control unit of the processor 1700, generating control signals that manage the operation of various components of the processor 1700. These control signals include enabling or disabling functional units, selecting data paths, initiating memory access, and coordinating timing of operations.

The controller 1702 may be configured to fetch (e.g., obtain, retrieve, receive) instructions from the memory 1704 and determine subsequent instruction(s) to be executed to cause the processor 1700 to support various operations in accordance with examples as described herein. The controller 1702 may be configured to track memory addresses of instructions associated with the memory 1704. The controller 1702 may be configured to decode instructions to determine the operation to be performed and the operands involved. For example, the controller 1702 may be configured to interpret the instruction and determine control signals to be output to other components of the processor 1700 to cause the processor 1700 to support various operations in accordance with examples as described herein. Additionally, or alternatively, the controller 1702 may be configured to manage flow of data within the processor 1700. The controller 1702 may be configured to control transfer of data between registers, ALUs 1706, and other functional units of the processor 1700.

The memory 1704 may include one or more caches (e.g., memory local to or included in the processor 1700 or other memory, such as RAM, ROM, DRAM, SDRAM, SRAM, MRAM, flash memory, etc. In some implementations, the memory 1704 may reside within or on a processor chipset (e.g., local to the processor 1700). In some other implementations, the memory 1704 may reside external to the processor chipset (e.g., remote to the processor 1700).

The memory 1704 may store computer-readable, computer-executable code including instructions that, when executed by the processor 1700, cause the processor 1700 to perform various functions described herein. The code may be stored in a non-transitory computer-readable medium such as system memory or another type of memory. The controller 1702 and/or the processor 1700 may be configured to execute computer-readable instructions stored in the memory 1704 to cause the processor 1700 to perform various functions. For example, the processor 1700 and/or the controller 1702 may be coupled with or to the memory 1704, the processor 1700, and the controller 1702, and may be configured to perform various functions described herein. In some examples, the processor 1700 may include multiple processors and the memory 1704 may include multiple memories. One or more of the multiple processors may be coupled with one or more of the multiple memories, which may, individually or collectively, be configured to perform various functions herein.

The one or more ALUs 1706 may be configured to support various operations in accordance with examples as described herein. In some implementations, the one or more ALUs 1706 may reside within or on a processor chipset (e.g., the processor 1700). In some other implementations, the one or more ALUs 1706 may reside external to the processor chipset (e.g., the processor 1700). One or more ALUs 1706 may perform one or more computations such as addition, subtraction, multiplication, and division on data. For example, one or more ALUs 1706 may receive input operands and an operation code, which determines an operation to be executed. One or more ALUs 1706 may be configured with a variety of logical and arithmetic circuits, including adders, subtractors, shifters, and logic gates, to process and manipulate the data according to the operation. Additionally, or alternatively, the one or more ALUs 1706 may support logical operations such as AND, OR, exclusive-OR (XOR), not-OR (NOR), and not-AND (NAND), enabling the one or more ALUs 1706 to handle conditional operations, comparisons, and bitwise operations.

The processor 1700 may support wireless communication in accordance with examples as disclosed herein. The processor 1700 may be configured to or operable to support at least one controller (e.g., the controller 1702) coupled with at least one memory (e.g., the memory 1704) and configured to cause the processor to: determine, for each UE in a group of UEs and based at least in part on both a wake-up delay offset of the UE and an ID of the UE, a subgroup of the group of UEs to which the UE belongs; and transmit, for each UE in the group of UEs and based at least in part on the subgroup of the UE, a LP-WUS that identifies the UE.

Additionally, the processor 1700 may be configured to or operable to support any one or combination of where the wake-up delay offset of the UE is based at least in part on an amount of time taken to wake-up a main radio of the UE; where the at least one controller is further operable to cause the processor to receive, for each UE in the group of UEs, an indication of the wake-up delay offset of the UE; where the at least one controller is further operable to cause the processor to assign, to the subgroup, a codepoint in a MO of a LP-WUS occasion; where the at least one controller is further operable to cause the processor to assign each UE of the group of UEs to a first level subgrouping of multiple first level subgroupings based at least in part on the wake-up delay offset of the UE; and assign, for each UE in a first level subgrouping of the multiple first level subgroupings, based at least in part on the ID of the UE, to a second level subgrouping of multiple second level subgroupings; where the at least one controller is further operable to cause the processor to assign, to UEs assigned to different first level subgroupings of the multiple first level subgroupings, different LP-WUS occasions and different periodicities; where the at least one controller is further operable to cause the processor to transmit a configuration for a UE of the group of UEs to monitor a PO of multiple POs in a first paging cycle corresponding to a LO in a second paging cycle that is different than the first paging cycle; where the processor is included in a base station.

The processor 1700 may support wireless communication in accordance with examples as disclosed herein. The processor 1700 may be configured to or operable to support at least one controller (e.g., the controller 1702) coupled with at least one memory (e.g., the memory 1704) and configured to cause the processor to: receive a configuration to monitor a LO corresponding to a wake-up delay offset of the processor; and monitor the LO based at least in part on the configuration.

Additionally, the processor 1700 may be configured to or operable to support any one or combination of the at least one controller is configured to cause the processor to monitor the LO for each PO; where the at least one controller is further operable to cause the processor to monitor the LO corresponding to one or more POs; where the wake-up delay offset of the processor is based at least in part on an amount of time taken to wake-up a main radio of the processor; where the at least one controller is further operable to cause the processor to transmit an indication of the wake-up delay offset of the processor; where the LO is in a first paging cycle and the configuration indicates to monitor a PO in a second that is different than the first paging cycle.

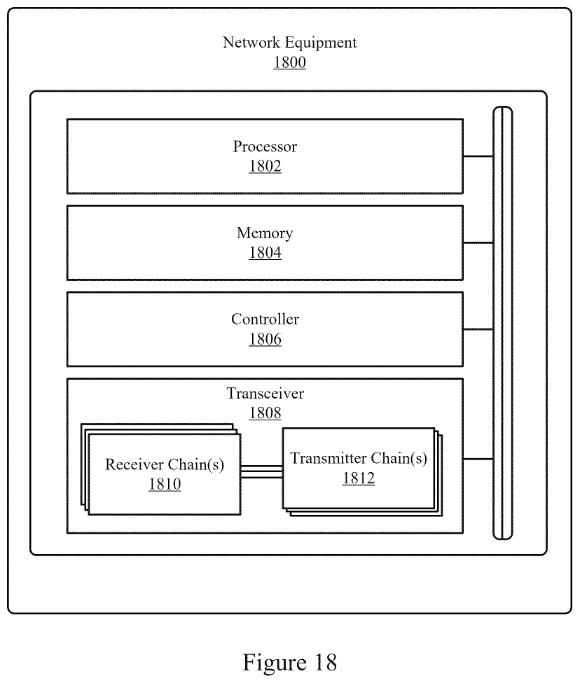

FIG. 18 illustrates an example of an NE 1800 in accordance with aspects of the present disclosure. The NE 1800 may include a processor 1802, a memory 1804, a controller 1806, and a transceiver 1808. The processor 1802, the memory 1804, the controller 1806, or the transceiver 1808, or various combinations thereof or various components thereof may be examples of means for performing various aspects of the present disclosure as described herein. These components may be coupled (e.g., operatively, communicatively, functionally, electronically, electrically) via one or more interfaces.

The processor 1802, the memory 1804, the controller 1806, or the transceiver 1808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1802 may include an intelligent hardware device (e.g., a general-purpose processor, a DSP, a CPU, an ASIC, an FPGA, or any combination thereof). In some implementations, the processor 1802 may be configured to operate the memory 1804. In some other implementations, the memory 1804 may be integrated into the processor 1802. The processor 1802 may be configured to execute computer-readable instructions stored in the memory 1804 to cause the NE 1800 to perform various functions of the present disclosure.

The memory 1804 may include volatile or non-volatile memory. The memory 1804 may store computer-readable, computer-executable code including instructions when executed by the processor 1802 cause the NE 1800 to perform various functions described herein. The code may be stored in a non-transitory computer-readable medium such as the memory 1804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1802 and the memory 1804 coupled with the processor 1802 may be configured to cause the NE 1800 to perform one or more of the functions described herein (e.g., executing, by the processor 1802, instructions stored in the memory 1804). For example, the processor 1802 may support wireless communication at the NE 1800 in accordance with examples as disclosed herein. The NE 1800 may be configured to support a means for determining, for each UE in a group of UEs and based at least in part on both a wake-up delay offset of the UE and an ID of the UE, a subgroup of the group of UEs to which the UE belongs; and transmitting, for each UE in the group of UEs and based at least in part on the subgroup of the UE, a LP-WUS that identifies the UE.

Additionally, the NE 1800 may be configured to support any one or combination of where the wake-up delay offset of the UE is based at least in part on an amount of time taken to wake-up a main radio of the UE; further including receiving, for each UE in the group of UEs, an indication of the wake-up delay offset of the UE; further including assigning, to the subgroup, a codepoint in a MO of a LP-WUS occasion; further including: assigning each UE of the group of UEs to a first level subgrouping of multiple first level subgroupings based at least in part on the wake-up delay offset of the UE; and assigning, for each UE in a first level subgrouping of the multiple first level subgroupings, based at least in part on the ID of the UE, to a second level subgrouping of multiple second level subgroupings; further including assigning, to UEs assigned to different first level subgroupings of the multiple first level subgroupings, different LP-WUS occasions and different periodicities; further including transmitting a configuration for a UE of the group of UEs to monitor a PO of multiple POs in a first paging cycle corresponding to a LO in a second paging cycle that is different than the first paging cycle; where the NE comprises a base station.

Additionally, or alternatively, the NE 1800 may support at least one memory (e.g., the memory 1804) and at least one processor (e.g., the processor 1802) coupled with the at least one memory and configured to cause the NE to: determine, for each UE in a group of UEs and based at least in part on both a wake-up delay offset of the UE and an ID of the UE, a subgroup of the group of UEs to which the UE belongs; and transmit, for each UE in the group of UEs and based at least in part on the subgroup of the UE, a LP-WUS that identifies the UE.

Additionally, the NE 1800 may be configured to support any one or combination of where the wake-up delay offset of the UE is based at least in part on an amount of time taken to wake-up a main radio of the UE; where the at least one processor is further operable to cause the NE to receive, for each UE in the group of UEs, an indication of the wake-up delay offset of the UE; where the at least one processor is further operable to cause the NE to assign, to the subgroup, a codepoint in a MO of a LP-WUS occasion; where the at least one processor is further operable to cause the NE to: assign each UE of the group of UEs to a first level subgrouping of multiple first level subgroupings based at least in part on the wake-up delay offset of the UE; and assign, for each UE in a first level subgrouping of the multiple first level subgroupings, based at least in part on the ID of the UE, to a second level subgrouping of multiple second level subgroupings; where the at least one processor is further operable to cause the NE to assign, to UEs assigned to different first level subgroupings of the multiple first level subgroupings, different LP-WUS occasions and different periodicities; where the at least one processor is further operable to cause the NE to transmit a configuration for a UE of the group of UEs to monitor a PO of multiple POs in a first paging cycle corresponding to a LO in a second paging cycle that is different than the first paging cycle; where the NE comprises a base station.

The controller 1806 may manage input and output signals for the NE 1800. The controller 1806 may also manage peripherals not integrated into the NE 1800. In some implementations, the controller 1806 may utilize an operating system such as iOS®, ANDROID®, WINDOWS®, or other operating systems. In some implementations, the controller 1806 may be implemented as part of the processor 1802.

In some implementations, the NE 1800 may include at least one transceiver 1808. In some other implementations, the NE 1800 may have more than one transceiver 1808. The transceiver 1808 may represent a wireless transceiver. The transceiver 1808 may include one or more receiver chains 1810, one or more transmitter chains 1812, or a combination thereof.

A receiver chain 1810 may be configured to receive signals (e.g., control information, data, packets) over a wireless medium. For example, the receiver chain 1810 may include one or more antennas to receive a signal over the air or wireless medium. The receiver chain 1810 may include at least one amplifier (e.g., a low-noise amplifier (LNA)) configured to amplify the received signal. The receiver chain 1810 may include at least one demodulator configured to demodulate the receive signal and obtain the transmitted data by reversing the modulation technique applied during transmission of the signal. The receiver chain 1810 may include at least one decoder for decoding the demodulated signal to receive the transmitted data.

A transmitter chain 1812 may be configured to generate and transmit signals (e.g., control information, data, packets). The transmitter chain 1812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1812 may also include at least one power amplifier configured to amplify the modulated signal to an appropriate power level suitable for transmission over the wireless medium. The transmitter chain 1812 may also include one or more antennas for transmitting the amplified signal into the air or wireless medium.

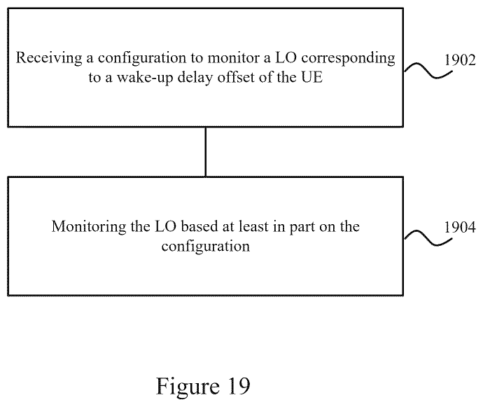

FIG. 19 illustrates a flowchart of a method in accordance with aspects of the present disclosure. The operations of the method may be implemented by a UE as described herein. In some implementations, the UE may execute a set of instructions to control the function elements of the UE to perform the described functions.

At 1902, the method may include receiving a configuration to monitor a LO corresponding to a wake-up delay offset of the UE. The operations of 1902 may be performed in accordance with examples as described herein. In some implementations, aspects of the operations of 1902 may be performed by a UE as described with reference to FIG. 16.

At 1904, the method may include monitoring the LO based at least in part on the configuration. The operations of 1904 may be performed in accordance with examples as described herein. In some implementations, aspects of the operations of 1904 may be performed by a UE as described with reference to FIG. 16.

It should be noted that the method described herein describes a possible implementation, and that the operations and the steps may be rearranged or otherwise modified and that other implementations are possible.

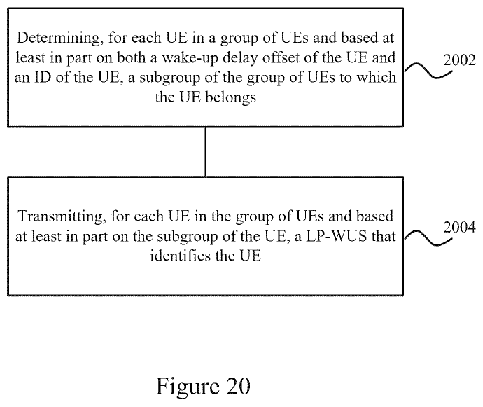

FIG. 20 illustrates a flowchart of a method in accordance with aspects of the present disclosure. The operations of the method may be implemented by an NE as described herein. In some implementations, the NE may execute a set of instructions to control the function elements of the NE to perform the described functions.

At 2002, the method may include determining, for each UE in a group of UEs and based at least in part on both a wake-up delay offset of the UE and an ID of the UE, a subgroup of the group of UEs to which the UE belongs. The operations of 2002 may be performed in accordance with examples as described herein. In some implementations, aspects of the operations of 2002 may be performed by an NE as described with reference to FIG. 18.

At 2004, the method may include transmitting, for each UE in the group of UEs and based at least in part on the subgroup of the UE, a LP-WUS that identifies the UE. The operations of 2004 may be performed in accordance with examples as described herein. In some implementations, aspects of the operations of 2004 may be performed by an NE as described with reference to FIG. 18.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and operable to cause the NE to:
determine, for each user equipment (UE) in a group of UEs and based at least in part on both a wake-up delay offset of the UE and an identifier (ID) of the UE, a subgroup of the group of UEs to which the UE belongs; and
transmit, for each UE in the group of UEs and based at least in part on the subgroup of the UE, a low power wake-up signal (LP-WUS) that identifies the UE.

2. The NE of claim 1, wherein the wake-up delay offset of the UE is based at least in part on an amount of time taken to wake-up a main radio of the UE.

3. The NE of claim 1, wherein the at least one processor is further operable to cause the NE to receive, for each UE in the group of UEs, an indication of the wake-up delay offset of the UE.

4. The NE of claim 1, wherein the at least one processor is further operable to cause the NE to assign, to the subgroup, a codepoint in a monitoring occasion (MO) of a LP-WUS occasion.

5. The NE of claim 1, wherein the at least one processor is further operable to cause the NE to:
assign each UE of the group of UEs to a first level subgrouping of multiple first level subgroupings based at least in part on the wake-up delay offset of the UE; and
assign, for each UE in a first level subgrouping of the multiple first level subgroupings, based at least in part on the ID of the UE, to a second level subgrouping of multiple second level subgroupings.

6. The NE of claim 5, wherein the at least one processor is further operable to cause the NE to assign, to UEs assigned to different first level subgroupings of the multiple first level subgroupings, different LP-WUS occasions and different periodicities.

7. The NE of claim 1, wherein the at least one processor is further operable to cause the NE to transmit a configuration for a UE of the group of UEs to monitor a PO of multiple POs in a first paging cycle corresponding to a low power wake-up signal occasion (LO) in a second paging cycle that is different than the first paging cycle.

8. The NE of claim 1, wherein the NE comprises a base station.

9. A user equipment (UE) for wireless communication, comprising:
at least one memory; and
at least one processor coupled with the at least one memory and operable to cause the UE to:
receive a configuration to monitor a low power wake-up signal occasion (LO) corresponding to a wake-up delay offset of the UE; and
monitor the LO based at least in part on the configuration.

10. The UE of claim 9, wherein the at least one processor is further operable to cause the UE to monitor the LO for each paging occasion (PO).

11. The UE of claim 9, wherein the at least one processor is further operable to cause the UE to monitor the LO corresponding to one or more paging occasions (POs).

12. The UE of claim 9, wherein the wake-up delay offset of the UE is based at least in part on an amount of time taken to wake-up a main radio of the UE.

13. The UE of claim 9, wherein the at least one processor is further operable to cause the UE to transmit an indication of the wake-up delay offset of the UE.

14. The UE of claim 9, wherein the LO is in a first paging cycle and the configuration indicates to monitor a paging occasion (PO) in a second that is different than the first paging cycle.

15. A method performed by a network equipment (NE), the method comprising:
determining, for each user equipment (UE) in a group of UEs and based at least in part on both a wake-up delay offset of the UE and an identifier (ID) of the UE, a subgroup of the group of UEs to which the UE belongs; and
transmitting, for each UE in the group of UEs and based at least in part on the subgroup of the UE, a low power wake-up signal (LP-WUS) that identifies the UE.

16. The method of claim 15, further comprising:
assigning each UE of the group of UEs to a first level subgrouping of multiple first level subgroupings based at least in part on the wake-up delay offset of the UE; and
assigning, for each UE in a first level subgrouping of the multiple first level subgroupings, based at least in part on the ID of the UE, to a second level subgrouping of multiple second level subgroupings.

17. The method of claim 16, further comprising assigning, to UEs assigned to different first level subgroupings of the multiple first level subgroupings, different LP-WUS occasions and different periodicities.

18. A method performed by a user equipment (UE), the method comprising:
receiving a configuration to monitor a low power wake-up signal occasion (LO) corresponding to a wake-up delay offset of the UE; and
monitoring the LO based at least in part on the configuration.

19. The method of claim 18, wherein the wake-up delay offset of the UE is based at least in part on an amount of time taken to wake-up a main radio of the UE.

20. The method of claim 18, further comprising transmitting an indication of the wake-up delay offset of the UE.
